(19) United States
(12) Patent Application Publication
(10) Pub. No.: US 2008/0196610 A1
(43) Pub. Date: Aug. 21, 2008

(54) ADJUSTING DEVICE AND METHOD FOR ROTARY PRINTING MACHINE

(76) Inventors: Roger ROCH, SENARCLENS (CH); Benoit ROSSET, DIVONNE-LES-BAINS (FR)

Correspondence Address: OSTROLENK FABER GERB & SOFFEN, 1180 AVENUE OF THE AMERICAS, NEW YORK, NY, 100368403, US

(21) Appl. No.: 12/035,189

(22) Filed: Feb. 21, 2008

(30) Foreign Application Priority Data
Feb. 21, 2007 (EP) 07003537.3

(51) Int. Cl. B41F 9/00; B41F 5/04; B41F 33/00

(52) U.S. Cl. 101/142; 101/219; 101/484

(57) ABSTRACT

A device for adjusting the position of a printing unit with respect to a printing web in a rotary printing machine comprising a control unit operable for controlling the movement of the printing unit from a predefined initial position Pᵢ to a predefined end position P_{f} by successive steps T. A vision system is operable for capturing images of the formats (F) which are successively printed on the printing web between the initial position Pᵢ and the end position P_{f}. A calculation unit is operable for evaluating the images and for determining the position Pₒₚₜ of the printing unit at which the images are identical and additionally the position at which the grayscale of the pixels of each image are identical.

### TECHNICAL FIELD

The present invention refers to a device for adjusting the position of a printing unit with respect to a printing web in a rotary printing machine comprising means for adjusting the position of said printing unit with respect to said printing web.

The invention also refers to a method for adjusting the position of a printing unit with respect to a printing web in a rotary printing machine.

The invention finally refers to a rotary printing machine comprising at least one printing unit suitable for transferring ink on a printing web for printing formats and comprising means for adjusting the position of said printing unit with respect to said printing web.

### BACKGROUND ART

A rotary printing machine usually comprises at least one printing unit connected to a counter-pressure cylinder which supports a printing web. The printing unit of a flexographic type printing machine usually consists of an assembly comprising a screen roll (or anilox cylinder) and a plate cylinder (or printing cylinder). In this kind of machine, the improvement of the print quality of the formats is achieved by the optimization of the adjustment of the relative position of the various cylinders involved in the printing process. The so-called format is the image obtained by the complete revolution of the plate cylinder on the printing web.

With known adjusting devices, the position of a printing unit with respect to a printing web is automatically adjusted owing to the closed-loop analysis of the images of the formats captured by a vision system. See for example patent application DE 4413735 A.

In this known type of adjusting device, the image of the format printed on the printing web is transmitted to a control unit that performs a continuous comparison in real time between the image and a reference image (or target image). According to this state in the art, as long as the image of the format does not correspond to the reference image, a control unit modifies the position of the printing unit with respect to the printing web. This adjustment is dynamic, i.e. the position of the printing unit can automatically change during production, according to the images captured by the vision system. Although such a device allows continuous correction in real time of a possible drift of the printed formats in production, it is not at all suitable for the adjustment of the rotary printing machine before starting the production, which is also called presetting.

Indeed, before starting a printing job, the rotary printing machine has to be preset. The presetting consists in putting the printing unit in contact with the printing web and advancing it by successive steps towards the counter-pressure cylinder while the web is running. During this time, the printed formats are checked by suitable means. When the required print quality of the formats is achieved, the advance of the printing unit is stopped, as the presetting is finished. The printing unit is then in a so-called optimal position, noted as Pₒₚₜ.

In a device according to the state of the art, the position of the printing unit is controlled by the vision system so that for changing from a position Pᵢ to a successive position Pᵢ₊₁, the operator must wait until the format printed by the printing unit passes in front of the vision system. The length of the web which has then run is equal to L+D, wherein L represents the length of a format and D the distance which separates the vision system from the printing unit, with L and D being expressed in meter. Thus, in order to pass successively from an initial position Pᵢ to an end position Pᵢ₊ₙ, wherein n represents the total number of advancing steps of the printing unit, n×(L+D) meters of web have to run in the printing machine. In other words, the length of the web which runs in the printing machine is proportional to the distance which separates the vision system from the printing unit, on the one hand, and to the length of the printed format, on the other hand.

During the presetting of a rotary printing machine, the web which runs in the machine while the printing unit advances towards the optimal position is lost web, also called waste. As the waste is a loss of material, it generates a production cost overrun. Thus, by using an adjusting device according to the state of the art for presetting a printing machine, the waste is proportional to the distance which separates the vision system from the printing unit, on the one hand, and to the length of the printed format, on the other hand, and this waste is not acceptable.

### SUMMARY OF THE INVENTION

An object of the present invention is to obviate the above drawbacks by proposing an adjusting device which limits the material waste at the time of the presetting of a rotary printing machine.

The invention concerns a device for adjusting the position of a printing unit with respect to a printing web in a rotary printing machine. The device comprises a control unit operable for controlling the movement of the printing unit from a predefined initial position Pᵢ to a predefined end position P_{f} by successive steps T. A vision system is operable for capturing images of the formats (F) which are successively printed on the printing web between the initial position Pi and the end position P_{f}. A calculation unit is operable for evaluating the images and for determining the position Pₒₚₜ of the printing unit at which the images are identical and additionally the position at which the grayscale of the pixels of each image are identical.

In an adjusting device according to the invention, the position of the printing unit is not controlled by the vision system. Owing to this new design, the waste is not proportional to the distance which separates the vision system from the printing unit but only proportional to the length of the printed format, and this enables considerable reduction of waste

Other features and advantages of the invention will be more clearly understood from the description of embodiments which refers to the accompanying drawings.

### BRIEF DESCRIPTION OF THE DRAWINGS

FIG. 1 is a schematic and partial view of a in-line flexographic printing machine;

FIG. 2 is a schematic and partial view of a flexographic printing machine with a central drum;

FIG. 3 is a diagram showing the evolution of the surface of the printed formats covered with ink in accordance with the advance of the printing unit; and

FIG. 4 is a schematic view of a printing web.

### DESCRIPTION OF A PREFERRED EMBODIMENT OF THE INVENTION

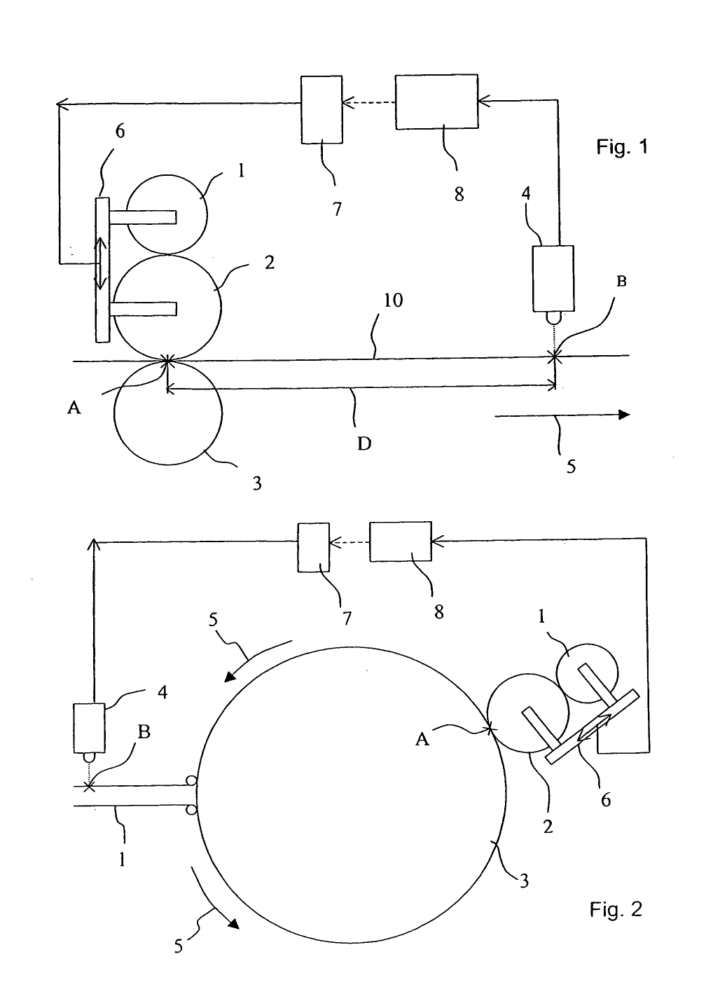

FIG. 1 shows an in-line flexographic printing machine. Its printing unit 6 comprises a screen roll (or anilox) 1 and a plate cylinder 2. The screen roll 1 is in contact with the plate cylinder 2 to ensure an adequate inking of the printing plate. The prepositioning of the screen roll 1 with respect to the plate cylinder 2 is known and is not part of the invention.

The plate cylinder 2 of the printing unit 6 is in contact with a printing web 10 which is supported by a counter-pressure cylinder 3. A camera 4 is placed downstream of the printing unit 6 on the path of the printing web in order to capture images of the formats printed on the printing web 10.

Putting the plate cylinder 2 into contact with the printing web 10 is a preliminary stage prior to the adjustment operation according to the invention. This preliminary stage is carried out without letting the printing machine run, that is, without letting the printing web run. The contact pressure of the plate cylinder 2 on the counter-pressure cylinder 3 is chosen to be adequate so that ink is transferred onto the printing web 10 but not to apply excessive pressure to avoid damaging the printing plate. Once this preliminary stage is carried out, adjusting the position of the printing unit 6 with respect to the printing web 10 can start.

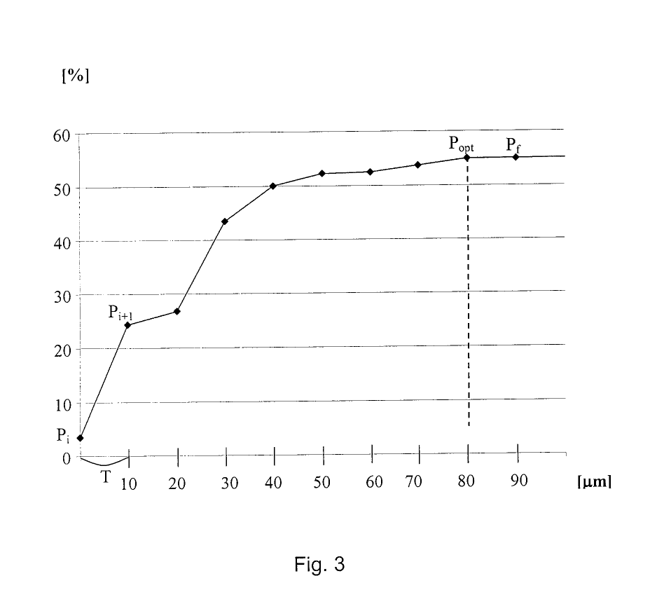

According to the invention, presetting the rotary printing machine is achieved in two phases. In a first phase, a control unit 7 controls the movement of the printing unit 6 from a predefined initial position Pᵢ to a predefined end position P_{f} by successive steps T, while the printing web 10 runs in the machine, in the running direction shown by arrow 5. The initial position Pᵢ corresponds to the position of the printing unit 6 at the end of the preliminary stage. The end position is defined by the choice of the length of the advance step T, on one hand, and by the total number of advancing movements of the printing unit, on the other hand. In the example, the step is 10 μm and the total number of advancing movements of the printing unit from the position Pᵢ is 9. Thus, the end position P_{f} is at 90 μm from the initial position Pᵢ. If only one format is printed for each position of the printing unit, 10 formats will be printed on the printing unit at the end of the first phase (see FIG. 3). For a number N of formats printed for each position of the printing unit, 10×N formats will be printed on the printing web at the end of the first phase.

In a second phase, the camera 4 captures images of the 10×N formats F printed on the printing web 10 during the first phase and transmits the images to a calculation unit 8 to be evaluated. The object of the evaluation is to determine the optimal position Pₒₚₜ, i.e. the position of the printing unit 6 for which a required printing quality of the formats F is reached. According to the invention, the position Pₒₚₜ corresponds to the position at which the images of the printed formats F are identical.

In a first evaluation mode, the unit 8 calculates the surface of 10×N printed formats F covered with ink. To this end, the unit 8 calculates the number of pixels of each image whose grayscale is different from the blank printing web. At the end of the second phase, the calculation unit 8 stores the position of the image at which the number of pixels of that image and successive images does not vary anymore, that is, the position at which the surface covered with ink becomes constant, as this position corresponds to the desired optimal position Pₒₚₜ. The optimal position Pₒₚₜ is also the first position for which the transfer of the ink reaches a maximum.

In a second evaluation mode, the unit 8 calculates the grayscale of each pixel composing the 10×N images. To this end, the unit 8 compares the grayscale of each pixel of a given image with the grayscale of the same pixel of the preceding image. At the end of the second phase, the calculation unit 8 stores the position of the image at which the grayscale does not vary anymore, in other words, the position at which the grayscale becomes constant, as this position corresponds to the desired optimal position Pₒₚₜ.

In the invention, the first phase of presetting the printing machine is independent of the second phase. This feature of the invention allows a faster presetting with less waste than does using existing adjusting devices. In fact, in an adjusting device according to the invention, the position of the printing unit 6 is not controlled by the camera 4 so that for passing from a position Pᵢ to a successive position Pᵢ₊₁, it is not necessary to wait until the format Fᵢ printed by the printing unit in the position Pᵢ passes in front of the camera 4. Thus by passing successively from an initial position Pᵢ to an end position P_{f} and by printing only one format for each position of the printing unit (i.e. N=1), the length of the web which runs in the printing machine is equal to (n×L)+D meters, wherein n represents the total number of advance steps of the printing unit 6, L the length of a format and D the distance which separates the camera 4 from the printing unit 6. Referring to FIG. 1, the distance D is the one which separates the point A from the point B.

Using the invention, the length of the web which runs in the printing machine during the presetting is not proportional to the distance which separates the camera 4 from the printing unit 6 but only proportional to the length of the printed format, which allows considerable reduction of waste.

FIG. 2 illustrates a flexographic printing machine with a central drum. As the description in relation to FIG. 1 is also valid for FIG. 2, it will not be repeated. It is noted that the distance D which separates the point A from the point B in the machine of FIG. 1 is measured along a line, whereas in the machine of FIG. 2 it is measured along a curve.

Advantageously, the optimal position Pₒₚₜ stored by the calculation unit 8 is transmitted to the control unit 7 for controlling the movement of the printing unit 6 from the end position P_{f} to the optimal position Pₒₚₜ at the end of the second phase. This embodiment is shown by a dotted arrow on FIGS. 1 and 2.

In the examples of printing machines illustrated in FIGS. 1 and 2, only one printing unit is shown. These machines can have a plurality of the printing units. The presetting method according to the invention is then implemented for each unit.

FIG. 3 is a diagram which illustrates by way of example, in relation to the first evaluation mode, the evolution of the surface of the printed formats covered with ink in accordance with the advance of the printing unit through steps T. The abscissa axis is expressed in micrometers, the ordinate axis is expressed in percentage of the surface of the printed formats covered with ink with respect to the total surface of the printed formats. Except for the fulltone, only a part of a given format is covered with ink, while the other part remains blank. Therefore, the total surface of the printed formats is the sum of the surfaces of the inked parts and the blank parts.

It can be observed that between zero (initial position Pi) and 80 μm, the surface of the printed formats covered with ink increases continuously. Then, from 80 μm, that covered surface becomes constant, so that the optimal position Popt is thus at 80 μm from the initial position Pi.

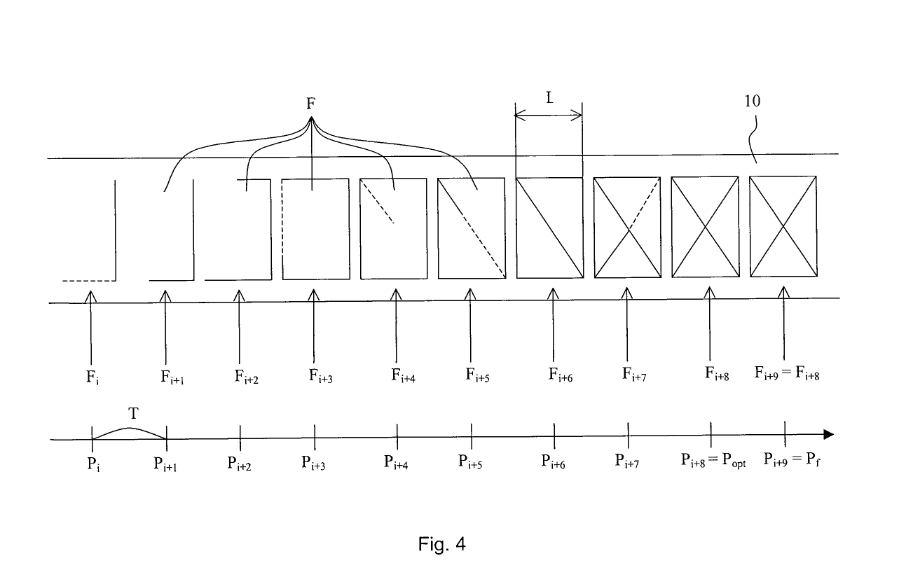

FIG. 4 shows a printing web 10 at the end of the first phase. On this web, ten formats of length L have been printed, one format per position of the printing unit 6. It is noted Fᵢ the format printed by the printing unit in the position Pᵢ, Fᵢ₊₁ the format printed by the printing unit in the next position Pᵢ₊₁, and so on. In this example, it can be observed that the formats Fᵢ₊₈ and Fᵢ₊₉ are identical, in other words Pₒₚₜ=Pᵢ₊₈. When using an adjusting device according to the invention for the presetting of a printing machine, the length of the web which has to run in the machine, the time required to find out the optimal position, is equal to (10×L)+D. For example, assuming that L is equal to 0.5 meters and D equal to 10 meters, the waste is thus 15 meters.

By way of comparison, when using an adjusting device according to the state of the art for the presetting of a printing machine, the length of the web which has to run in the printing machine, the time required to find out the optimal position, is equal to 9×(L+D). Then, by taking the previous numerical values, the waste is of 94.5 meters.

Thus, owing to the invention as explained for this example, the waste is reduced of more than 80%. Moreover, for a given web speed, the invention also allows to reduce the presetting time by more than 80% as an example.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A device for adjusting the position of a printing unit with respect to a printing web in a rotary printing machine, the device comprising:
a control unit operable for controlling the movement of the printing unit from a predefined initial position Pᵢ to a predefined end position P_{f} by successive steps T,
a vision system operable for capturing images of formats which are successively printed on the printing web between the initial position Pᵢ and the end position P_{f},
a calculation unit operable for evaluating the images and for determining a position Pₒₚₜ of the printing unit after the initial position at which the successively printed images are identical.

2. The adjusting device according to claim 1, wherein the calculation unit is operable for calculating the surface of each of the printed formats that is covered with ink and for determining the position Pₒₚₜ of the printing unit at which the surface of successive formats covered with ink is constant.

3. The adjusting device according to claim 1, wherein the calculation unit is operable for calculating the grayscale of each pixel composing the images and for determining the position Pₒₚₜ of the printing unit at which the grayscale of correspondingly located successive formats is constant.

4. A flexographic printing machine comprising at least one printing unit operable for transferring ink on a printing web for printing formats and a device for adjusting the position of the printing unit with respect to the printing web according to claim 1.

5. A method for adjusting the position of a printing unit with respect to a printing web in a rotary printing machine, comprising
moving the printing unit from a predefined initial position Pᵢ to a predefined end position P_{f} by successive steps T,
at each position, printing a format;
capturing images of the formats which are successively printed on said printing web from the initial position Pᵢ to the end position P_{f} and transmitting the captured images to a calculation unit operable for evaluating the images and for determining the position Pₒₚₜ of the printing unit at which successive images are identical.

6. The adjusting method according to claim 5, further comprising the calculation unit calculating the surface of each of the printed formats that is covered with ink and determining the position Pₒₚₜ of the printing unit at which the surface at each format that is covered with ink is constant.

7. The adjusting method according to claim 5, further comprising the calculation unit also calculating the grayscale of each pixel composing each of the images of the formats and determining the position Pₒₚₜ of the printing unit at which the grayscale of each pixel of each format is constant.
